(19) United States
(12) Patent Application Publication
(10) Pub. No.: US 2004/0066392 A1
(43) Pub. Date: Apr. 8, 2004

(54) Region selection device, region selection method and region selection program

(75) Inventor: Hitoshi Ueda, Hachioji-shi (JP)

Correspondence Address: FRISHAUF, HOLTZ, GOODMAN & CHICK, PC, 767 THIRD AVENUE, 25TH FLOOR, NEW YORK, NY, 10017-2023, US

(73) Assignee: Olympus Optical Co., Ltd., Tokyo (JP)

(21) Appl. No.: 10/649,888

(22) Filed: Aug. 26, 2003

(30) Foreign Application Priority Data
Aug. 29, 2002 (JP) 2002-251725

(51) Int. Cl. G09G 5/00

(52) U.S. Cl. 345/629

(57) ABSTRACT

A region selection device, which select one region from among a plurality of regions displayed on a display screen, according to a first aspect of the present invention includes a coordinate input unit for inputting coordinate information to the display screen, a region table which stores attributes of the plurality of regions, a display for displaying the plurality of regions on the display screen according to the attributes stored in the region table, and a region selector for, when the regions displayed on the display screen lie on top of one another, selecting a predetermined region according to priorities corresponding to a feature parameter which is at least one of the attributes of the plurality of regions.

### CROSS-REFERENCE TO RELATED APPLICATIONS

This application is based upon and claims the benefit of priority from the prior Japanese Patent Application No. 2002-251725, filed Aug. 29, 2002, the entire contents of which are incorporated herein by reference.

### BACKGROUND OF THE INVENTION

1. Field of the Invention

The present invention relates to an image input device for a microscope system by way of example and more specifically to a region selection device which selects an interest region (ROI) from among regions provided on a display screen on which an image is displayed, a region selection method, and a region selection program.

2. Description of the Related Art

In recent years, in the field of image processing, the enhanced performance of personal computers (PCs) has realized an image input device which obtains and displays moving images and captures a still image after confirmation of shooting conditions of the moving images. Such an image input device is configured such that, on a moving image display screen, an automatic exposure region for automatic calculation of an exposure time, a focus region for calculation of focus evaluation, a white balance region for calculation of white balance, a black balance region for calculation of black balance, and a clip region indicating a capture range of a still image are displayed, and each of the regions can be moved and changed in size. Each of the regions is displayed on the display screen at the same time. While moving, enlarging and reducing the regions according to the conditions of the subject, the work of selecting a desired one from the overlapped regions is frequently performed.

FIGS. 1A and 1B illustrate a first prior art. For example, regions A, B and C and a cursor 2001 are displayed on the display screen so that they can be moved by operating a coordinate input device such as a mouse. FIG. 1A is a front view of an image, while FIG. 1B is a side view of the image.

An operation of selecting a desired region A (B, C) from the overlapped regions A, B, and C will be described below.

A description is given of an example of selecting the backmost region C from the overlapped regions A, B, and C. First, the coordinate input device is operated to specify coordinates in the front region A.

Subsequently, when the coordinate input device is moved with its button pressed, the X, Y coordinates indicating the display position of the region A are changed accordingly. Thereby, the region A is moved in a vertical or horizontal direction of the two-dimensional plane according to the position of the cursor 2001.

The same operation as above is performed on the region B as well after the region A has been removed from above the regions B and C, whereby all the regions overlapped on the region C are removed. Next, the coordinates in the region C is specified by operating the mouse and the region C is selected by pressing the mouse button.

As a second prior art to select a desired one from overlapped regions, the following system is known. The topmost region A is specified with the cursor 2001 and then the button of the coordinate input device is pressed. As the result, a menu is displayed which allows the order in which the regions are laid on top of one another to be changed. The operator is thus allowed to make a selection from the menu to change the order in which the regions are overlapped.

With such a system, such a menu as shown in FIG. 2A is displayed by first positioning the cursor 2001 on the region A and then pressing the button of the coordinate input device. By, at this point, moving the cursor 2001 to “Move to backmost side” on the menu as shown in FIG. 2A and then pressing the mouse button, the region A is moved to the backmost side as shown in FIG. 2B. After the region A has been moved to the backmost side in this manner, the same operation as above is performed on the region B as well to make the region C the topmost region. Next, the coordinates of the region C are specified by the coordinate input device and then its button is pressed to thereby select the region C.

In a third prior art (see Japanese Patent Application KOKAI Publication No. 5-165593), region selection means for selecting a desired one from overlapped regions has a button or a pressure sensor provided in coordinate input means. A desired one is selected from the overlapped regions by pressing the button or by switching the selected regions one after another according to the output of the pressure sensor provided in the coordinate input device.

With the third prior art, by first positioning the cursor on the region C and then pressing the button once, the region A is placed in the selected state as shown in FIG. 3A. By pressing the button once more, the region B is placed in the selected state as shown in FIG. 3B. By next pressing the button, the region C is selected. Another method to select the region C is to adjust the force by which the button is pressed. In this case, pressing the button lightly causes the topmost one of the overlapped regions to be selected. Pressing the button most strongly causes the backmost region to be selected.

### BRIEF SUMMARY OF THE INVENTION

A region selection device, which select one region from among a plurality of regions displayed on a display screen, according to a first aspect of the present invention is characterized by comprising: coordinate input means for inputting coordinate information to the display screen; a region table which stores attributes of the plurality of regions; display means for displaying the plurality of regions on the display screen according to the attributes stored in the region table; and region selection means for, when the regions displayed on the display screen lie on top of one another, selecting a predetermined region according to priorities corresponding to a feature parameter which is at least one of the attributes of the plurality of regions.

A region selection device of selecting one region from among a plurality of regions displayed on a display screen, according to a second aspect of the present invention is characterized by comprising: inputting coordinate information to the display screen; displaying the plurality of regions on the display screen according to attributes of the plurality of regions stored in a region table; and selecting a predetermined region according to priorities corresponding to a feature parameter which is at least one of the attributes of the plurality of regions when the plurality of regions displayed on the display screen are overlapped.

A computer program according to a third aspect of the present invention is a computer program product configured to store program instructions of selecting one region from among a plurality of regions displayed on a display screen for execution on a computer system enabling the computer system and the computer program is characterized by perform: inputting coordinate information to the display screen; displaying regions on the display screen according to attributes of the plurality of regions stored in a region table; and selecting a given region according to priorities corresponding to a feature parameter which is at least one of the attributes of the plurality of regions when the plurality of regions displayed on the display screen are overlapped.

Advantages of the invention will be set forth in the description which follows, and in part will be obvious from the description, may be learned by practice of the invention. Advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and detailed description of the embodiments given below, serve to explain the principles of the invention.

FIGS. 1A and 1B are diagrams for explaining a first prior art;

FIGS. 2A and 2B are diagrams for explaining a second prior art;

FIGS. 3A and 3B are diagrams for explaining a third prior art;

FIG. 4 is a block diagram showing a configuration of a region selection device according to an embodiment of the present invention;

FIG. 5 is a diagram for explaining an example of region information stored in the region table of FIG. 4;

FIG. 6 shows a configuration of the region table of FIG. 4;

FIG. 7 is a diagram for explaining a state where regions are displayed in FIG. 4;

FIG. 8 is a flowchart illustrating a region selection method and program according to the first embodiment of the present invention;

FIGS. 9A, 9B and 9C are diagrams for explaining region selected states and the shapes of a cursor in FIG. 4;

FIG. 10 is a flowchart illustrating a processing operation of rearranging regions in FIG. 4;

FIG. 11 is a flowchart illustrating a processing operation of clearing the state where all the regions are selected in FIG. 4;

FIG. 12 is a flowchart illustrating a processing operation of deciding the selected state of the borderline of a region in FIG. 4;

FIG. 13 is a flowchart illustrating a processing operation of clearing the selected state of the inside of a region in FIG. 4;

FIG. 14 is a flowchart illustrating a processing operation of moving a region and changing its size in FIG. 4;

FIGS. 15A and 15B respectively show an operation of changing the size of a region and an operation of moving a region in FIG. 4;

FIG. 16 shows another embodiment of the present invention;

FIG. 17 is a flowchart illustrating a processing operation of determining the priorities of the regions which are of the same area but different shapes in FIG. 16;

FIG. 18 is a diagram for explaining a configuration of the region table in accordance with another embodiment of the present invention;

FIGS. 19A and 19B show display examples when regions are locked and unlocked in FIG. 18;

FIG. 20 shows an example of displaying the priorities of regions according to a further embodiment of the present invention; and

FIG. 21A to FIG. 21D show examples of displaying borderlines in an animation-like fashion according to another embodiment of the present invention.

### DETAILED DESCRIPTION OF THE INVENTION

The preferred embodiments will now be described with reference to the accompanying drawings.

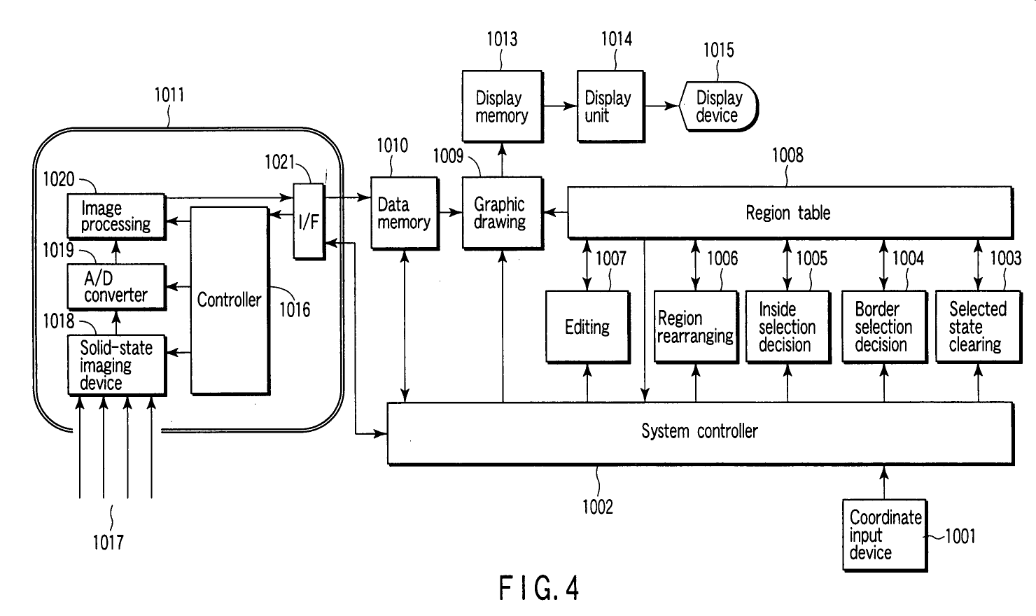

FIG. 4 is a schematic illustration of a region selection device according to an embodiment of the present invention. A coordinate input device 1001 is equipped with coordinate input means, such as a button-mounted mouse, a trackball, etc., which is adapted to input X and Y coordinates P on a display screen specified by a user.

To the coordinate input device 1001 is connected a system controller 1002 which comprises a computer and receives the X and Y coordinates P input by the coordinate input means. When the coordinate input means of the coordinate input device 1001 is operated again and consequently the position of the coordinates P is changed, region selecting/editing information, such as notification of movement of the coordinates P, ON/OFF information of the button, etc., is output to the system controller 1002.

The system controller 1002 controls the whole system in accordance with a control program and outputs corresponding information to each processing section in accordance with information received from the coordinate input device 1001.

The system controller 1002 receives information from the coordinate input device 1001 and holds the most recent information. When inquired by a processing section, the system controller 1002 notifies it of the most recent state of the coordinate input device 1001. To this end, the system controller 1002 holds the most recent information concerning the position of the point P, the ON/OFF state of the button, etc.

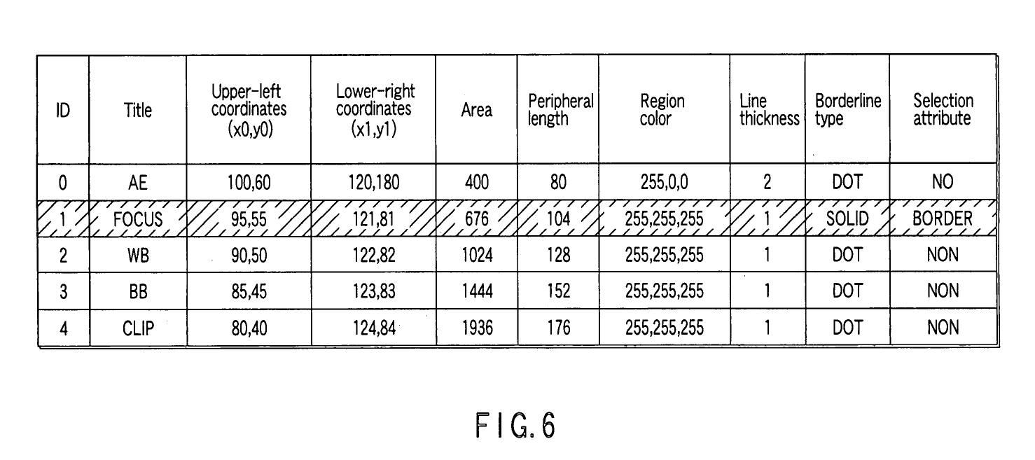

To the system controller 1002 is connected a region table 1008 which holds information about regions which are set in an image input device 1011 and displayed on the display screen. The region table 1008 manages regions and their associated coordinates. For example, as shown in FIG. 5, each region has its position and size managed in terms of the coordinates on the upper left and the coordinates on the lower right. In addition to these coordinates, as shown in FIG. 6, the region table 1008 holds, for each region, the title, the area, the perimeter, the color, the line thickness, the borderline type, and the selection attribute as region attributes.

The title of each region is composed of a character string representing the role of that region. The coordinates on the upper left and the coordinates on the lower right have been described in connection with FIG. 5. The area is the area of the region calculated from its coordinates. The perimeter is the perimeter of the region. The color is the color of the borderline of the region expressed in terms of R, G and B values. The line thickness is the thickness of the borderline of the region. The line thickness increases when the region is placed in the selected state. The line type is the type of the borderline. In FIG. 6, DOT indicates a dotted line, while SOLID indicates a solid line. When the region is in the selected state, SOLID is specified; otherwise, DOT is specified. The selection attribute is specified as BORDER when the borderline is selected. When the inside of the region is selected, the attribute is specified as INSIDE. When the region is not selected, the attribute is specified as NON.

FIG. 6 indicates that the borderline of the region 1 is selected.

At system startup, a region rearranging section 1006 rearranges the regions in the region table 1008 in accordance with a feature parameter of the regions, which will be described in detail later. In the present embodiment, the areas of the regions are set as the feature parameter by which the order in which the regions are rearranged is determined. The regions are rearranged in order of increasing area.

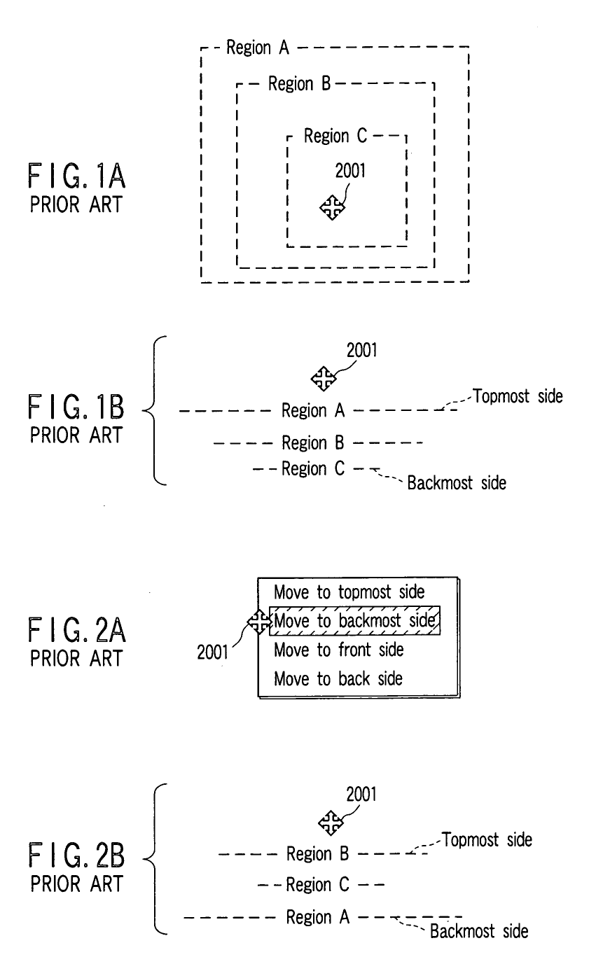

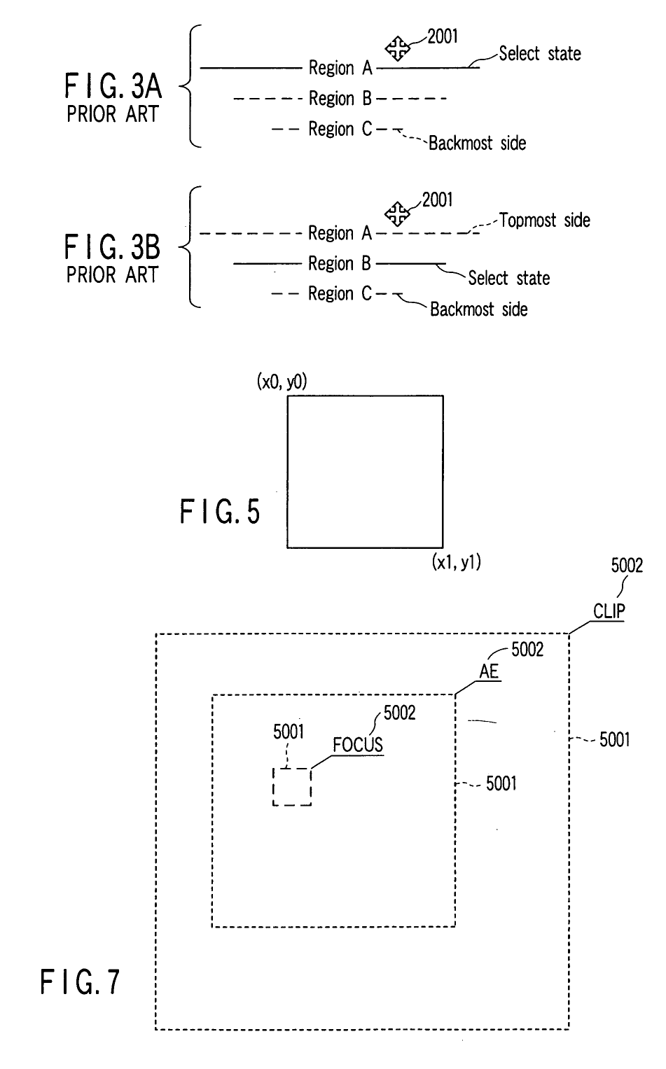

The order of the regions after being rearranged forms the order of retrieving the regions by a border selection decision section 1004 or an inside selection decision section 1005 controlled by the system controller 1002. That is, the order in which the regions are listed in the region table 1008 forms the priorities to be used in deciding whether to select a region. Therefore, the smallest region enclosing the cursor 2001 is placed in the selected state by priority, which allows regions to be selected by intuition (see FIGS. 1A and 1B).

To the system controller 1002 is connected a selected state clearing section 1003, which has a function of changing the selection attribute of every region retained in the region table 1008 to NON.

The region selection decision section 1004, the inside selection decision section 1005, the region rearranging section 1006, an editing section 1007 and a data memory 1010 are connected to the system controller 1002.

The border selection decision section 1004 compares the coordinates of a point P input from the coordinate input device 1001 with the borderlines of each region in the region table 1008 in sequence starting with the region listed at the top of the region table. This is intended to decide whether or not the point P is located on a borderline.

The inside selection decision section 1005 compares the coordinates of a point P input from the coordinate input device 1001 with the borderlines of each region in the region table 1008 in sequence starting with the region listed at the top of the region table, thereby deciding whether or not the point P is located on the inside of a region.

The region rearranging section 1006 rearranges the regions in the region table 1008 according to their specific feature parameter.

The editing section 1007 moves a region being selected or changes its size.

The data memory 1010 is written with, for example, a raster image from an interface (I/F) 1021 of an image input device 1011 that forms first display means, which will be described later.

The image input device 1011 is connected to the system controller 1002 through the interface 1021. The image input device 1011 is composed of a controller 1016, a solid-state imaging device 1018, such as a CCD (Charge Coupled Device), which converts light beams 1017 into analog electrical signals, an A/D converter 1019 which converts the analog electrical signals into digital signals, an image processing unit 1020 which performs color processing on a digital image and outputs a raster image, and the interface (I/F) 1021 which transfers the raster image to the data memory 1010.

The interface 1021 links the system controller 1002 and the image input device controller 1016 for transfer of instructions and data, such as the region table 1008, therebetween.

The image input device 1011 is placed on the TV (television) light path of a microscope so that the light beams 1017 that form a microscope image are projected onto the solid-state imaging device 1018. The solid-state imaging device 1018 converts the projected optical image (light beams) into analog electrical signals, which are in turn output to the A/D converter 1019. The A/D converter 1019 converts the analog electrical signals into digital signals and outputs the resulting digital signals to the image processing unit 1020.

The image processing unit 1020 performs color reproduction processing on the digital signals and produces a raster image. The raster image is transferred to the data memory 1010 through the interface 1021. Upon completion of the transfer of the raster image, the interface 1021 notifies the system controller 1002 to that effect. Upon receipt of the notification, the system controller 1002 instructs the a graphic drawing unit 1009 that forms second display means to draw graphics.

The image input device controller 1016 has an automatic exposure control function of performing such exposure control as makes the brightness of a resultant image proper on the basis of image data in a specific area of the solid-state imaging device 1018, a white balance function of performing such control as makes the color whiter, a black balance function of performing such control as makes the brightness darker, a focus evaluation function of calculating the evaluated value for focusing, and a clip function of specifying the range of a still image to be obtained.

The regions on which the above functions are performed are obtained from the region table 1008 via the system controller 1002 and the interface 1021.

The graphic drawing unit 1009, which is connected to the system controller 1002, the region table 1008, and the data memory 1010, performs the overall graphic processing as controlled by the system controller 1002 and transfers an image to a display memory 1013 which will be described later. That is, the graphic drawing unit 1009 obtains a raster image from the data memory 1010, and draws regions on the basis of individual region attributes in the region table 1008 and combines them with the raster image. The graphic drawing unit 1009 obtains the coordinates of a point P from the coordinate input device 1001, then draws the cursor 2001 in the corresponding position on the raster image and outputs the resulting composite raster image to the display memory 1013.

As shown in FIG. 7, the borderlines 5001 of regions and the titles 5002 of the regions are drawn on the raster image. Each of the titles is associated with a corresponding one of the regions by a leader line drawn out of it. The borderlines of the regions are drawn according to their attributes. That is, the type (either solid or dotted), the thickness and the color of each borderline to be drawn depends on the attributes of the corresponding region.

The display memory 1013, which has, for example, a dual-port RAM, holds the contents to be displayed by a display unit 1014 to be described later. The display unit 1014 reads data out of the display memory 1013 and displays it on a display device 1015, such as a CRT.

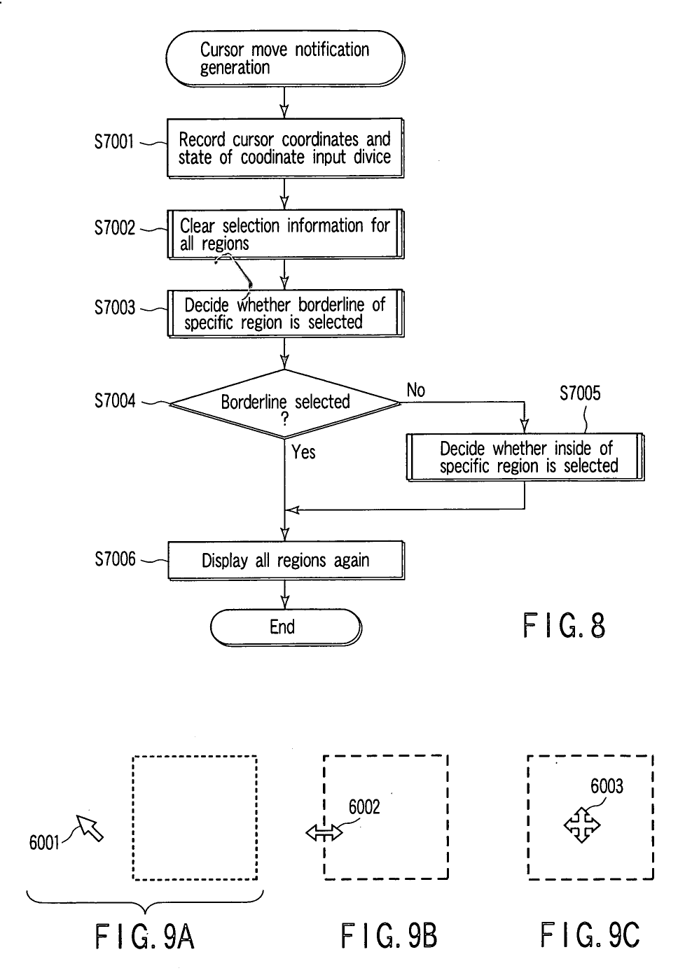

A region select operation will now be described with reference to FIG. 8.

First, when the coordinate input device 1001 is operated, the coordinates P specified by the coordinate input device 1001 and notification of coordinate movement including the ON/OFF state of the button are output to the system controller 1002. Upon receipt of the notification of coordinate movement, the system controller 1002 stores the received coordinates P and the button state of the coordinate input device 1001 into its internal register (step S7001).

Next, the system controller 1002 invokes the selected state clearing section 1003 (step S7002). The selected state clearing section 1003 then clears flags indicating selected states for all the regions in the region table 1008 (step S7002). That is, all the regions are placed in non-selected state.

Next, the system controller 1002 invokes the border selection decision section 1004. The border selection decision section 1004 decides whether the coordinates P are located on a borderline of a region, that is, the borderline of a specific region is selected (step S7003). If the decision in step S7004 is that there is a region whose borderline is being selected (YES), the procedure advances to step S7006.

If, on the other hand, NO in step S7004, that is, there is no region whose borderline is selected, the procedure advances to step S7005. In step S7005, the system controller 1002 invokes the inside selection decision section 1005 and causes it to make a decision of whether the coordinates P are located on the inside of a specific region. If the coordinates P are located on the inside of a specific region, it is decided that the inside has been selected. As a result, the attribute of the selected region in the region table 1008 is changed to the inside selected state.

If, in step S7005, the coordinates P are not included in any region, it follows that there is no selected region because the selected states of all of the regions have been cleared in step S7002.

In step S7006, the system controller 1002 instructs the graphic drawing unit 1009 to draw regions according their attributes in the region table 1008. The graphic drawing unit 1009 reads a raster image written from the image input device 1011 into the data memory 1010 and then draws all the regions in the region table 1008 according to their attributes. For example, the graphic drawing unit 1009 draws the frames of selected regions in bold strokes.

When all the regions have been drawn and there is a region in selected state, the cursor 2001 is drawn in the position of the coordinates P on the raster image. When there is no selected region, the cursor, in the shape of an arrow, is drawn in the position of the coordinates P.

When there is no selected region, such a normal cursor 6001 in the shape of an arrow as shown in FIG. 9A is drawn. When there is a region whose borderline is selected, a cursor 6002 which is shaped as shown in FIG. 9B is drawn. When the inside of a region is selected, a cursor 6003 which is shaped as shown in FIG. 9C is drawn. This allows the user to confirm selected portions more easily.

Upon completion of drawing onto the raster image, the graphic drawing unit 1009 transfers the resulting raster image to the display memory 1013.

The region selection processing will be described in detail.

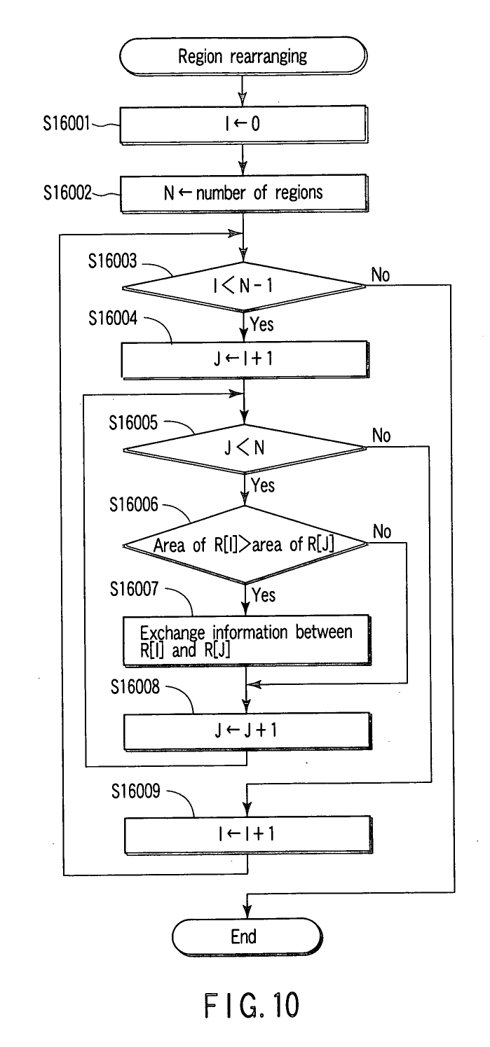

The region rearranging processing, which is to rearrange the items in the region table 1008 in order of increasing region area, is general processing using such a bubble sort as shown in FIG. 10 as the basic algorithm. Since the bubble sort is a well known technique, the detailed description of steps S16001 through S16005 is omitted. In the present embodiment, a comparison between regions R[I] and R[J] in the bubble sort is made in terms of the area of region. The processing is performed so that the regions are headed by the region of the smallest area (steps S16006 and S16007). Then, counter J is incremented by one and the procedure returns step S16005 (step S16008). In step S16005, if J is smaller than N, I is incremented by one and the procedure returns step S16003 (step S16009)

Here, the K-th region in the region table 1008 is represented as R[K]. For example, the 0-th region is represented as R[0]. The same representations are also used in the description which follows.

Since the above description makes an assumption that the number of regions is small, for example, less than 10, use is made of the bubble sort which is capable of fast processing when the number of pieces of data is small. In a system in which the number of regions is large, however, use may be made of an algorithm, such as a quick sort, which is effective when the number of pieces of data is large. The present invention is not dependent particularly on a rearranging algorithm.

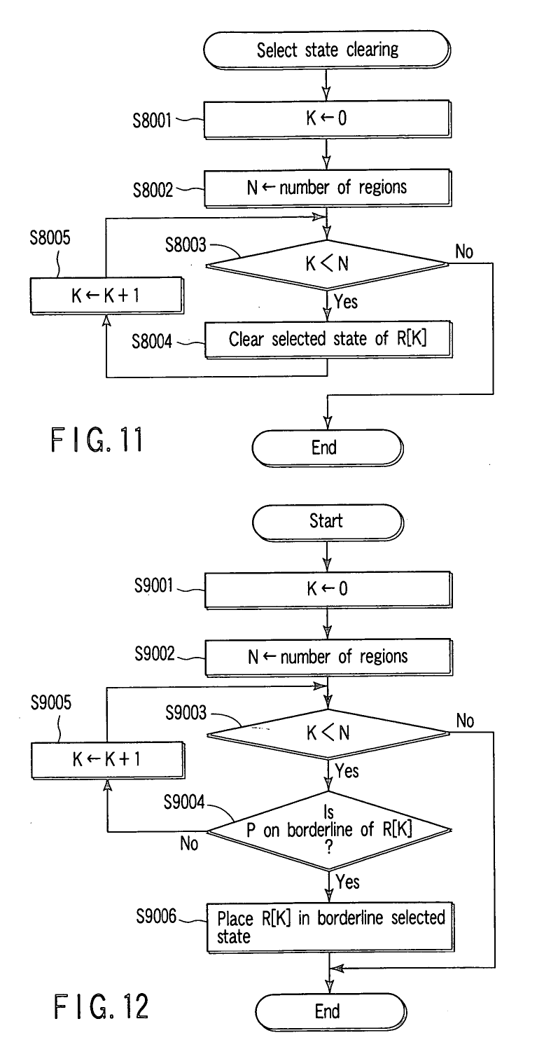

Here, the processing operation of the selected state clearing section 1003 will be described with reference to FIG. 11.

When invoked by the system controller 1002, the selected state clearing section 1003 resets the counter K indicating the region number to 0 (step S8001) and then sets the variable N to the number of regions (step S8002).

Next, the selected state clearing section 1003 decides whether or not K<N is satisfied (step S8003). If K <N indicating that unprocessed regions are left, then the selected state of the region R[K] is cleared (step S8004).

Subsequently, the counter K is incremented by one (step S8005) and the procedure then advances to step S8003. The above processing is repeated until K <N becomes unsatisfied. Thus, all the regions in the region table 1008 enter the non-selected state.

Reference is next made to FIG. 12 to describe the processing operation of the border selection decision section 1004.

When invoked by the system controller 1002, the border selection decision section 1004 resets the counter K indicating the region number to 0 (step S9001) and then sets the variable N to the number of regions (step S9002). Next, a decision is made as to whether or not K<N is satisfied (step S9003). If K<N indicating that unchecked regions are left, then a decision is made as to whether the coordinates P are located on the borderline of the region R[K] (step S9004).

If the coordinates P are located on the borderline of the region R[K], then the selected state attribute of the region R[K] is changed to the borderline selected state by considering that borderline as being selected (step S9006). Thus, the border selection decision processing comes to an end. If, in this case, two or more borderlines lie on top of one another at the coordinates P, only the region of the smallest area enters the selected state because the regions in the region table has been arranged in order of increasing area.

If the coordinates P are not located on the borderline of the region R[K], the counter K is incremented by one for a comparison between the next region and the coordinates P (step S9005) and then return is made to step S9003. The above processing is repeated until K<N becomes unsatisfied in step S9003. The border selection decision processing is performed until a region the borderline of which the coordinates P are located on is found or on all the regions. A region the borderline of which the coordinates P are located on is placed in the borderline selected state.

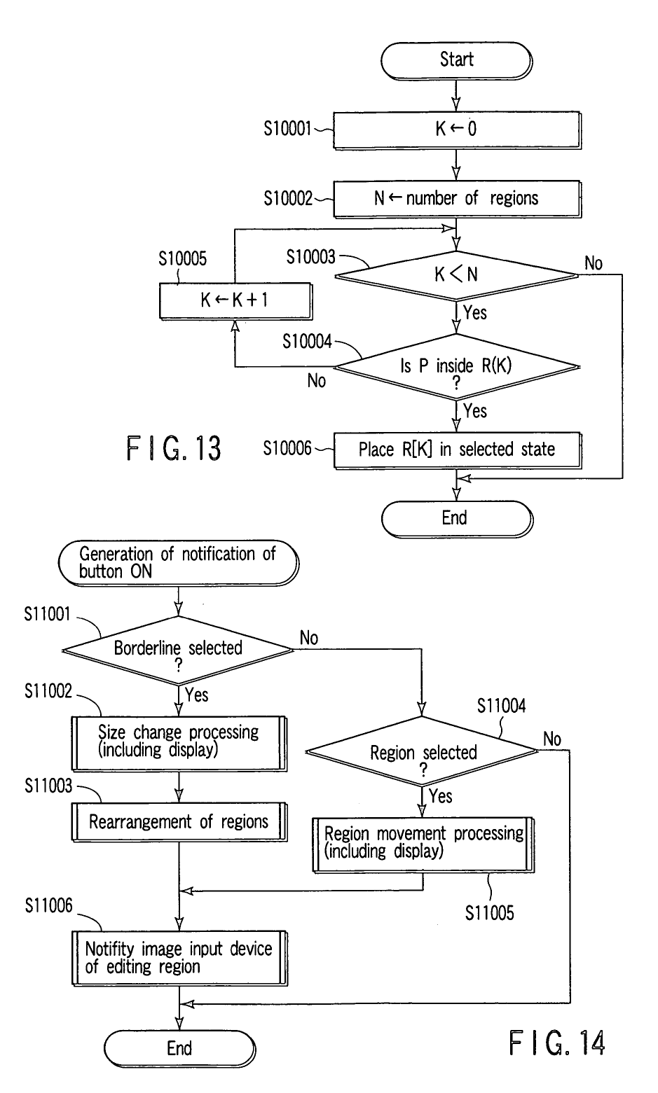

The processing operation of the inside selection decision section 1005 will be described below with reference to FIG. 13.

When invoked by the system controller 1002, the inside selection decision section 1005 resets the counter K indicating the region number to 0 (step S10001) and then sets the variable N to the number of regions (step S10002). Next, a decision is made as to whether or not K<N is satisfied (step S10003). If K<N indicating that unchecked regions are left, then a decision is made as to whether the coordinates P are located on the inside of the region R[K] (step S10004).

If the coordinates P are located on the inside of the region R[K], then the selected state attribute of the region R[K] is changed to the inside selected state by considering that its inside as being selected (step S10006). Thus, the inside selection decision processing comes to an end. If, in this case, two or more regions lie on top of one another at the coordinates P, only the region of the smallest area enters the selected state because the regions in the region table has been arranged in order of increasing area.

If the coordinates P are not located on the inside of the region R[K], the counter K is incremented by one for a comparison between the next region and the coordinates P (step S10005) and then return is made to step S10003. The above processing is repeated until K<N becomes unsatisfied in step S9003. The inside selection decision processing is performed until a region the inside of which the coordinates P are located on is found or on all the regions. A region the inside of which the coordinates P are located on is placed in the inside selected state.

The above procedures allow region selection to be made to fit the sense of a person who have decided the selected states of all the regions each time the cursor 2001 corresponding to the coordinates P input by the coordinate input device 1001 is moved.

The processing operation of the editing section 1007 which moves a region and changes its size will be described with reference to FIG. 14.

The editing section 1007 is connected to the system controller 1002 and invoked by the system controller 1002 when the button of the coordinate input device 1001 is pressed (ON). When invoked, the editing section 1007 decides whether there exists a region whose borderline has been selected and, if there exists, advances to the size change processing (step S11001).

In the size change processing, while the button of the coordinate input device 1001 is being pressed, the size of the region being selected is changed according to the distance traveled by the coordinates P. When the button of the coordinate input device 1001 is released (OFF), the area of the region whose size has been changed is calculated and the corresponding attribute is updated. Thus, the size change processing comes to an end (step S11002).

Upon completion of the size change processing, the priorities used in selecting the regions are changed because the area of the region being selected has been changed. The region rearranging section 1006 rearranges the regions in the region table 1008 in order of increasing area, thereby terminating the editing processing (step S11003).

If, in step S11001, there exists no region whose borderline has been selected, then a decision is made as to whether or not there exists a region whose inside has been selected (step S11004). If, in step S11004, there exists a region whose inside has been selected, the procedure advances to region movement processing. If, on the other hand, there exists no region whose inside has been selected, the procedure is completed.

In the region movement processing, while the button of the coordinate input device 1001 is being pressed (ON), the position of the region being selected is changed according to the distance traveled by the coordinates P. When the button of the coordinate input device 1001 is released (OFF), the region movement processing comes to an end (step S11005).

Thus, when the borderline of a region is selected, pressing the button of the coordinate input device 1001 to move the cursor 2001 corresponding to the coordinates P indicated by the coordinate input device 1001 allows the size of that region to be changed. When the inside of a region is selected, pressing the button of the coordinate input device 1001 allows that region to be moved. The user is thus allowed to change the size of a region or move a region by intuition.

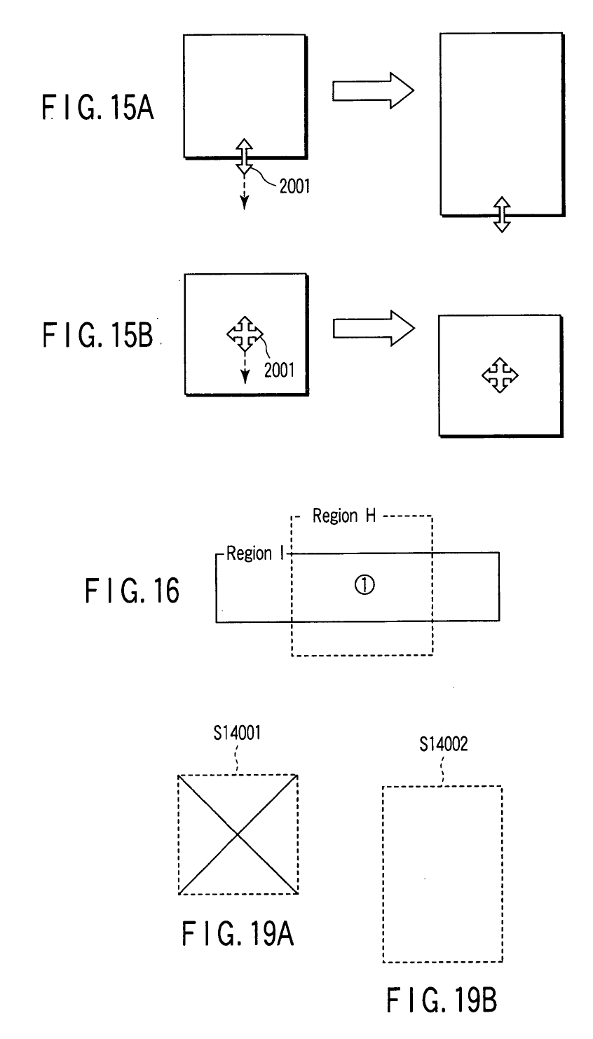

When the borderline of a region is selected, the shape of the cursor 2001 becomes as depicted in FIG. 15A. When the cursor is moved downward while the button of the coordinate input device 1001 is being pressed, the region can be prolonged downward.

When the inside of a region is selected, the shape of the cursor 2001 becomes as depicted in FIG. 15B. When the cursor is moved downward while the button of the coordinate input device 1001 is being pressed, the entire region can be moved downward.

Thus, the abovementioned region selection device is configured to, when the cursor 2001 is moved according to coordinates input from the coordinate input device 1001, compare all the regions with the coordinates in order of increasing area with each movement of the cursor and consider a region in which the coordinates are included in the first place to be selected. This allows the operation of selecting a region to be controlled to the minimum and region selection to be made to fit the human sense. Moreover, there is no need for a coordinate input device specially designed for region selection, allowing the configuration to be simplified.

Also, with the abovementioned region selection method, when the cursor 2001 is moved according to coordinates input from the coordinate input device 1001, the system controller 1002 compares all the regions with the coordinates in order of increasing area in time sequence at each position of the cursor and considers a region in which the coordinates are included in the first place to be selected.

This allows the operation of selecting a region to be controlled to the minimum, fast selection processing to be realized and region selection to be made to fit the human sense. Moreover, there is no need for a coordinate input device 1001 specially designed for region selection, allowing the configuration to be simplified.

Also, according to the abovementioned region selection program, when the cursor 2001 is moved according to coordinates input from the coordinate input device 1001, the system controller 1002 compares all the regions with the coordinates in order of increasing area at each position of the cursor and considers a region in which the coordinates are included in the first place to be selected.

This allows the operation of selecting a region to be controlled to the minimum, fast selection processing to be realized and region selection to be made automatically to fit the human sense. Moreover, there is no need for a coordinate input device 1001 specially designed for region selection, allowing the configuration to be simplified.

The present invention is not limited to the abovementioned embodiment, but is also applicable to such a case as shown in FIG. 16 in which two regions H and I which are of the same area but different in shape are placed one on top of the other. In such a case, by causing one region which is longer in perimeter to have precedence over the other, the region I can be selected intuitively.

That is, in this case, it is natural and intuitive that, in position \mathring{1}, the region I enters the selected state. As described previously, the region I and the region H is identical in area to each other, but the region H is longer in perimeter than the region I. The closer a region is to a square, the shorter its perimeter is. When two regions with the same area are overlapped, Sensuously, shorter one becomes behind.

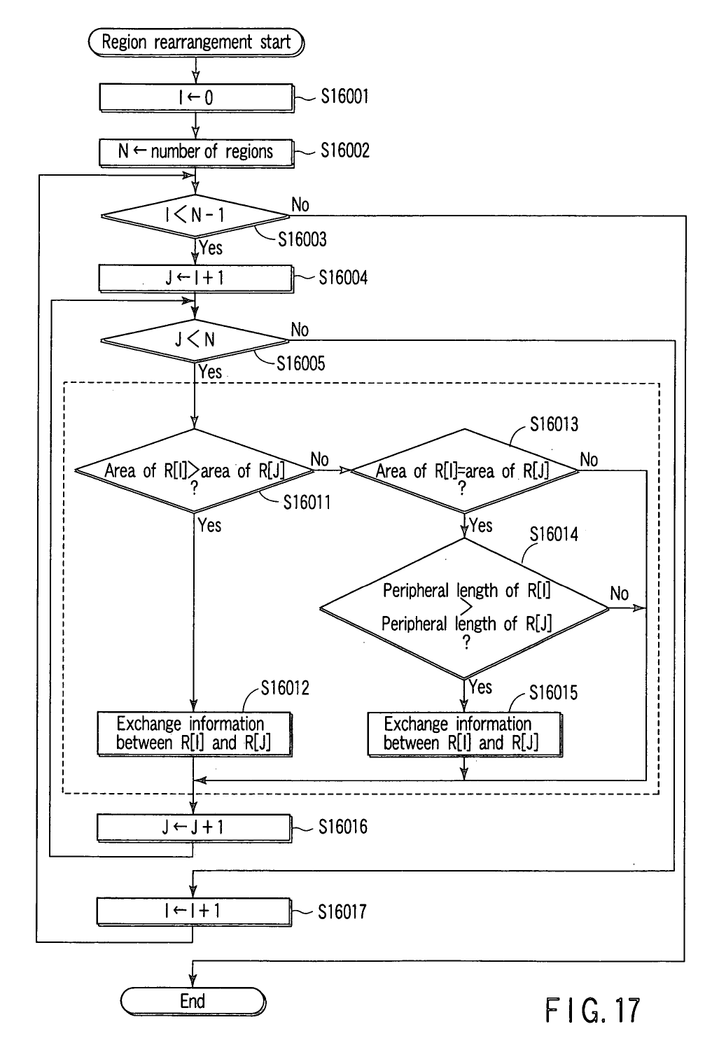

The regions H and I are rearranged in accordance with a procedure shown in FIG. 17. The procedure of FIG. 17 allows regions of the same area to be rearranged by replacing steps S16006 and S16007 in FIG. 10 by steps S16011 through S16017. The corresponding parts to those in FIG. 10 are denoted by like reference numerals and descriptions thereof are omitted for convenience of explanation.

In the bubble sort rearrangement decision block, a decision is made as to whether the area of the region R[I] is larger than that of the region R[J] (step S16011). If YES, an exchange of the attributes is made between the regions R[I] and R[J] (step S16012).

If NO in step S16011, a decision is made as to whether the area of the region R[I] is equal to that of the region R[J] (step S16013). If YES, then a comparison is made in perimeter between the regions R[I] and R[J] (step S16014).

That is, in step S16014, a decision is made as to whether the perimeter of the region R[J] is larger than that of the region R[I]. If YES, the region R[J] is selected by priority. The procedure advances to step S16015 where an exchange of the attributes is made between R[J] and R[I] so that the region R[J] is placed in the upper portion of the region table 1008. If NO in step S16016, then the procedure advances through step S16016 to step S16005.

If NO in step S16003, the procedure advances to step S16017 and advances to step S1605 again and the above-mentioned processing is continued.

Thus, even if regions with the same area are overlapped, it becomes possible to intuitively make a selection between the regions by causing one of them which is larger in perimeter to have precedence over the other.

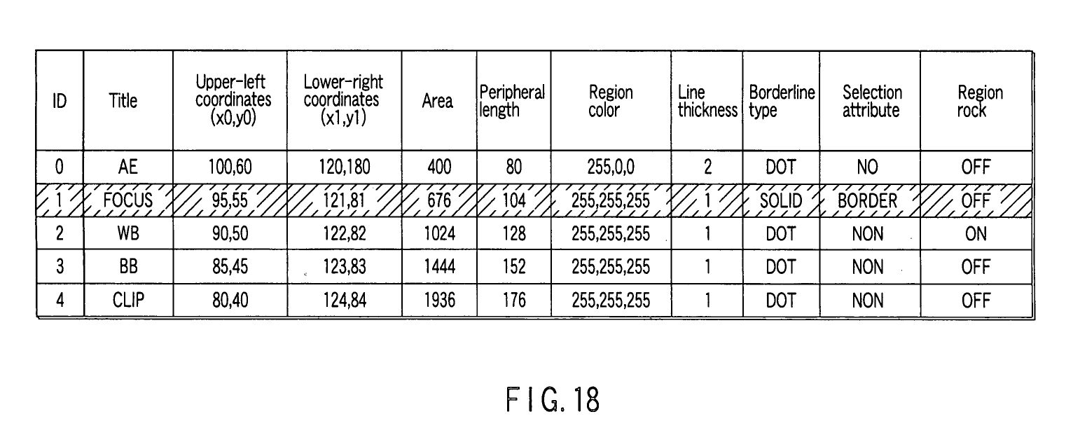

The present invention is not limited to the present embodiment. For example, the coordinate input device 1001 may be equipped with a region lock button to fix the position of a specific region and control the movement and change in size of it. By so doing, it becomes possible to, after the position of an important interest region has been specified, prevent it from being moved or changed in size by mistake. In that case, the region lock attribute is added to the region table 1008 as shown in FIG. 18. In the initial state, the region lock attribute is set OFF for all the regions.

In the above configuration, when two or more regions are displayed on the display device 1015 (see FIG. 4), coordinates are input by the coordinate input device (see FIG. 4) to select a region. If, when the borderline or inside of a region is being selected, the region lock button (not shown) is pressed (ON), the system controller 1002 (see FIG. 4) receives region lock button ON information and then outputs it to the editing section 1007 (see FIG. 4). The editing section then sets ON the region lock attribute of the selected region.

When the size of a region is changed or it is moved as in the case of the present embodiment, that is, when the editing processing of FIG. 14 is carried out, the editing section 1007 confirms the state of the region lock attribute of the region being selected. When the attribute has been set ON, the editing section does not perform any editing process such as of changing the size of the region or moving it. If the region lock attribute is set OFF, the editing section performs a process of moving the region or changing its size as with the embodiment.

If, when a region for which the region lock attribute has been set ON is being selected, the region lock button (not shown) of the coordinate input device 1001 is pressed, the locked state is released. The lock attribute of the region being selected is reset to OFF by a process similar to the region locking process.

The graphic drawing section 1009 (see FIG. 4) displays the region for which the region lock attribute has been set ON in such a way that the user can know its locked state. A form of this display is illustrated in FIG. 19A. FIG. 19B shows the normal (unlocked) state. To display the locked state in such a form as shown in FIG. 19A, in drawing a region the graphic drawing section 1009 refers to its region lock attribute and then draws diagonals of that region together with its borderline when its lock attribute is in the ON state. When the lock attribute is in the OFF state, only the borderline of the region is drawn as shown in FIG. 19B.

According to the present embodiment, by locking a region considered important by the user, it becomes possible to effectively prevent that region from being moved by mistake.

The present invention is not limited to the present embodiment. For example, the graphic drawing section 1009 may be configured to make the color of the cursor 2001 variable according the selected states of regions.

To this end, the color information of a region whose borderline or inside is selected is obtained in steps S7003 and S7005 in FIG. 8. In step S7006 in FIG. 8, when the cursor 2001 is drawn in the position of the coordinates P input from the coordinate input device 1001, a desired color is applied to the cursor on the basis of the previously obtained color information.

According to the present embodiment, by allowing the cursor 2001 to be set to the same color as a region in the selected state, it becomes possible to identify regions in the selected states with ease even in the case where there are many regions.

The present invention is not limited to the present embodiment. For example, it is also possible to change the order of rearrangement of the regions in the region table 1008 and change the region-selecting priorities according to the operating states of the system.

That is, when the state of the image input device 1011 is changed, operating information is output to the system controller 1002. The system controller thereupon causes the region rearranging section 1006 to rearrange the regions in the region table 1008 so that the region relevant to the state of the image input device 1011 is shifted to the top of the table.

In the case of a microscope system, the system controller 1002 shifts the region most relevant to the state of the microscope system to the top of the region table 1008. After that, desired regions are likewise selected on the basis of the region table.

According to the present embodiment, regions that can be selected by priority can be changed according to the state of the system; thus allowing invalid operations by the user to be restricted and the number of operations to be reduced.

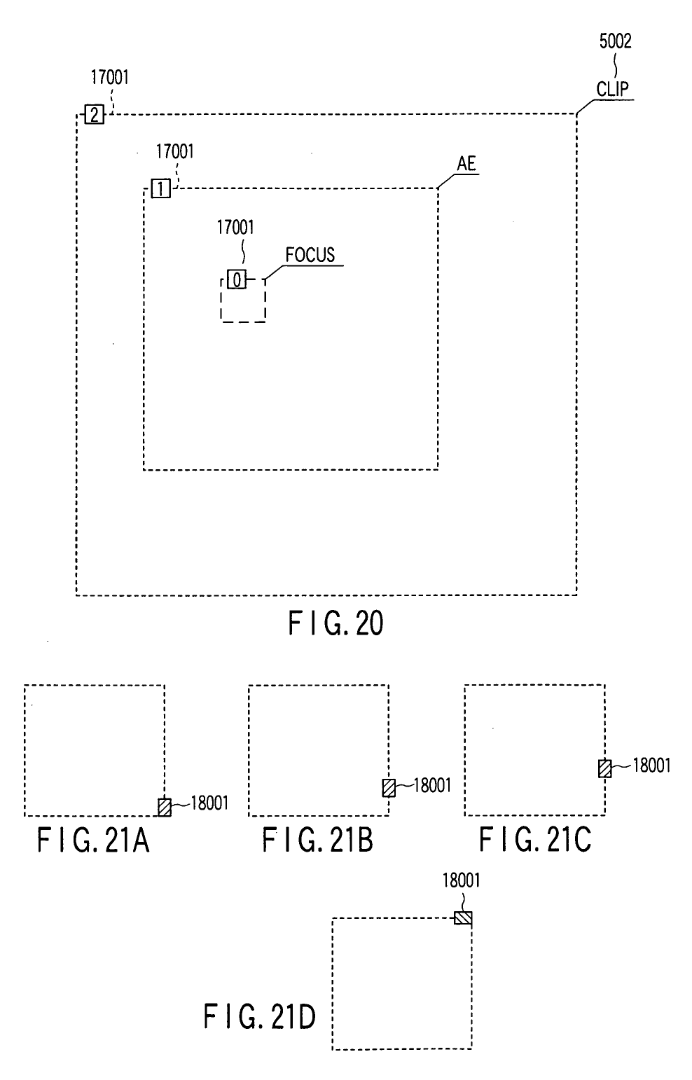

The present invention is not limited to the present embodiment. For example, as shown in FIG. 20, when the graphic drawing section 1009 displays the regions in the region table 1008, numbers 17001 ([0], [1], [2]) corresponding to the order in which they are arranged may be attached to the regions In the above configuration, the order in which regions are arranged in the region table 1008 is equivalent to the region-selecting priorities. Thus, even if, when an attribute other than area is used as the attribute by which the order of rearrangement is determined, the user changes the region-selecting priorities according to the system state as in the present embodiment, it becomes possible to confirm the region-selecting priorities immediately, allowing the operability to be further improved.

Moreover, numerical values corresponding to the priorities of the regions can be calculated from (number of regions—priority) to display the borderline of a region of higher priority in bolder strokes. This allows the priorities of the regions to be confirmed more easily.

According to the present embodiment, the region-selecting priorities can be represented visually, which helps the user to select the regions and allows the region selecting operations to be further simplified.

The present invention is not limited to the present embodiment. For example, the system controller 1002 may be equipped with a timer not shown to display the borderline of a region being selected in an animation-like fashion.

That is, the timer in the system controller 1002 generates an interruption to the graphic drawing section 1009 at regular intervals. Upon receipt of an interruption, the graphic drawing section draws a region being selected again. A selected region counter is incremented by one each time an interruption is received from the timer. The counter is reset to zero when a count corresponding to the perimeter of the region is reached.

For example, as shown in FIG. 21A to FIG. 21D, a mark 18001 is displayed which moves on the borderline of a region. The mark is moved by a predetermined amount on the borderline by incrementing the counter each time an interruption is received from the timer, thereby displaying the borderline in an animation-like fashion. When the lower left corner of the region is made to correspond to the count “0” in the counter, the mark is displayed at the lower left corner of the region as shown in FIG. 21A when the count in the counter is 0. The mark 18001 is moved along the borderline with time as shown in FIGS. 21A through 21D. Finally, the mark returns to the position of FIG. 21A. While the region is selected, the movement of the mark is repeated.

According to the present embodiment, by displaying a selected region in an animation-like fashion, the user's visibility of regions can be further improved and the operability can be improved.

Although the present embodiment has been described as constituting the coordinate input device 1001 through the use of a mouse or trackball, this is not restrictive. Any other device, such as a tablet and stylus pen, which can specify coordinates on a display screen may be used.

Although the present embodiment has been described by way of an example in which the regions are rectangular in shape, this is not restrictive. regions of various shapes may be set up.

According to the embodiments of the present invention, a region selection device, a region selecting method and a region selecting program can be provided which allow a high-precision region selecting operation to be performed with ease with the configuration made simple and the number of operations kept to the minimum.

The following inventions can be extracted from the embodiments. The inventions may be used individually or in combination.

A region selection device according to a first aspect of the present invention is characterized by a region selection device which select one region from among a plurality of regions displayed on a display screen comprising: coordinate input means for inputting coordinate information to the display screen; a region table which stores attributes of the regions; display means for displaying the regions on the display screen according to the attributes stored in the region table; and region selection means for, when the regions displayed on the display screen lie on top of one another, selecting a given region according to priorities corresponding to a feature parameter which is at least one of the attributes of the regions.

When the coordinates are moved to a specific region or its borderline by the coordinate input device, region selection is made by the region selection means according to priorities corresponding to a feature parameter of the overlapped regions. This allows a desired region or its borderline to be selected by intuition with no need of complicated operations.

In the first aspect, the region selection device may be practiced as follows:

(1) The region selection means first decides whether or not the border of a region is selected and then decides whether the inside of the region is selected. Region selection can be made with reliability and precision by the use of two types of feature parameters.

(2) The feature parameter is the area of each region. Reliable and stable region selection can be made with ease.

(3) The feature parameter is the perimeter of each region. Reliable and stable region selection can be made with ease.

(4) The feature parameter is the area and the perimeter of each region. More reliable and stable region selection can be made.

(5) The region table stores information for invalidating the editing of a region as one of the attributes. This provides the diversification of region selection and improves the operability.

A region selecting method of selecting one region from among a plurality of regions displayed on a display screen according to a second aspect of the present invention is characterized by comprising:

inputting coordinate information to the display screen;

displaying the regions on the display screen according to attributes of the regions stored in a region table;

and when the regions displayed on the display screen lie on top of one another, selecting a given region according to priorities corresponding to a feature parameter which is at least one of the attributes of the plurality of regions.

When the coordinates are moved to a specific region or its borderline, region selection is made according to priorities corresponding to a feature parameter of the overlapped regions. This allows a desired region or its borderline to be selected by intuition with no need of complicated operations.

A computer-readable region selecting program for selecting one region from among a plurality of regions displayed on a display screen according to a third aspect of the present invention is characterized by comprising: inputting coordinate information to the display screen; displaying regions on the display screen according to attributes of the regions stored in a region table; and when the regions displayed on the display screen lie on top of one another, selecting a given region according to priorities corresponding to a feature parameter which is at least one of the attributes of the plurality of regions.

When the coordinates are moved to a specific region or its borderline, region selection is made according to priorities corresponding to a feature parameter of the overlapped regions. This allows a desired region or its borderline to be selected by intuition with no need of complicated operations.

The present invention may be practiced or embodied in still other ways without departing from the scope and spirit thereof. In addition, the above embodiments include inventions at various stages and various inventions can be extracted by proper combinations of disclosed constituent elements.

Even if several constituent elements are removed from all the constituent elements pointed out in each embodiment, if the problems the invention is to solve are solved and the advantages the invention is to provide are obtained, a configuration which has those constituent elements removed can be extracted as an invention.

Additional advantages and modifications will readily occur to those skilled in the art. Therefore, the present invention in its broader aspects is not limited to the specific details, representative devices, and illustrated examples shown and described herein. Accordingly, various modifications may be made without departing from the spirit or scope of the general inventive concept as defined by the appended claims and their equivalents.

What is claimed is:

1. A region selection device which select one region from among a plurality of regions displayed on a display screen comprising:
coordinate input means for inputting coordinate information to the display screen;
a region table which stores attributes of the plurality of regions;
display means for displaying the plurality of regions on the display screen according to the attributes stored in the region table; and
region selection means for, when the regions displayed on the display screen lie on top of one another, selecting a predetermined region according to priorities corresponding to a feature parameter which is at least one of the attributes of the plurality of regions.

2. The region selection device according to claim 1, wherein the region table stores information for invalidating the editing of a region as one of the attributes.

3. The region selection device according to claim 1, wherein the region selection means first decides whether or not the border of a region is selected and then decides whether the inside of the region is selected.

4. The region selection device according to claim 3, wherein the region table stores information for invalidating the editing of a region as one of the attributes.

5. The region selection device according to claim 1, wherein the feature parameter is an area of each region.

6. The region selection device according to claim 4, wherein the region table stores information for invalidating the editing of a region as one of the attributes.

7. The region selection device according to claim 1, wherein the feature parameter is a perimeter of each region.

8. The region selection device according to claim 7, wherein the region table stores information for invalidating the editing of a region as one of the attributes.

9. The region selection device according to claim 1, wherein the feature parameter is both of an area and a perimeter of each region.

10. The region selection device according to claim 9, wherein the region table stores information for invalidating the editing of a region as one of the attributes.

11. A region selecting method of selecting one region from among a plurality of regions displayed on a display screen comprising:
inputting coordinate information to the display screen;
displaying the plurality of regions on the display screen according to attributes of the plurality of regions stored in a region table; and
selecting a predetermined region according to priorities corresponding to a feature parameter which is at least one of the attributes of the plurality of regions when the plurality of regions displayed on the display screen are overlapped.

12. A computer program product configured to store program instructions of selecting one region from among a plurality of regions displayed on a display screen for execution on a computer system enabling the computer system to perform:
inputting coordinate information to the display screen;
displaying regions on the display screen according to attributes of the plurality of regions stored in a region table; and
selecting a given region according to priorities corresponding to a feature parameter which is at least one of the attributes of the plurality of regions when the plurality of regions displayed on the display screen are overlapped.
